(19) United States
(12) Patent Application Publication
(10) Pub. No.: US 2019/0061401 A1
(43) Pub. Date: Feb. 28, 2019

(54) TRANSFER PAPER FOR TRANSFER PRINTING

(71) Applicant: KYOCERA Document Solutions Inc., Osaka (JP)

(72) Inventor: Yoshio OZAWA, Osaka (JP)

(73) Assignee: KYOCERA Document Solutions Inc., Osaka (JP)

(21) Appl. No.: 16/046,610

(22) Filed: Jul. 26, 2018

(30) Foreign Application Priority Data
Aug. 22, 2017 (JP) 2017-159316

(51) Int. Cl. B41M 5/44

(52) U.S. Cl. CPC B41M 5/44

(57) ABSTRACT

Transfer paper for transfer printing has an image formed on its surface with a water-based transfer-printing ink containing a pigment and a fixing resin ejected from an ink-jet recording device, and is then, with cloth laid over it, heated so that the image is transferred to the cloth. The transfer paper has a base layer and a surface layer. The surface layer is composed of a hydrophilic ink reception layer laid on the base layer and a releasing layer forming agent containing an emulsion of hydrophobic particles having their surface coated with a hydrophilic emulsifier.

### INCORPORATION BY REFERENCE

This application is based on and claims the benefit of Japanese Patent Application No. 2017-159316 filed on Aug. 22, 2017, the contents of which are hereby incorporated by reference.

### BACKGROUND

The present disclosure relates to transfer paper for transfer printing (transfer-printing transfer paper) for use in a transfer-printing method in which an image recorded on transfer paper by an ink-jet recording device is transferred to a recording sheet.

Conventionally, screen printing, roller printing, and the like are widely used as methods for printing on cloth such as cotton, silk, and polyester. These printing methods require different screen frames, engraved rollers, and the like for different print patterns, and are thus unsuitable for printing in small-volume large-variety production, They also require the washing-away of a sizing agent and the like, and produce large amounts of waste water, posing a problem of increased burden on the environment. In contrast, ink-jet printing does not require pattern-making for screen frames or engraved rollers, and allows change of print patterns and colors simply through change of digital data; it is thus suitable for small-volume large-variety production. Also, ink-jet printing produces far less waste water. It has thus come to be used increasingly widely today.

Known ink-jet printing methods include a direct printing method, in which an image is printed directly on cloth on an ink-jet printer, and a transfer printing method, in which an image is printed on special paper (transfer paper) on an ink-jet printer and then only the ink on the transfer paper is transferred to cloth on a thermal transfer device.

In a direct printing method, an image is printed while cloth is transported at high speed; thus, bringing an ink-jet head too close to the cloth causes, due to fluff on the surface of the cloth, wear and scratches on the ink-jet head. Thus, a given distance has to be left between the ink-jet head and the cloth. Inconveniently, a greater distance between the ink-jet head and the cloth tends to lead to a disturbed image, and cloth having an image printed inappropriately on it has to be scrapped.

On the other hand, a transfer printing method has, to name a few, the following advantages. The absence of a step involving direct transport of cloth to a printer makes a disturbed image less likely, and allows high-quality, high-definition printing of images on cloth. Owing to image printing using an ink-jet printer being performed on transfer paper, an inappropriately printed image does not require scrapping of cloth. Only a comparatively small distance has to be left between an ink-jet head and transfer paper, and this allows high-quality image printing with little contamination with ink mist.

One commonly practiced type of such a transfer printing method is a sublimation printing method employing a sublimation dye. For example, one known type of sublimation ink-jet printing transfer paper has, on a base material, a sublimation printing ink reception layer containing a water-soluble resin and fine particles, and this design gives it superb ink absorption, drying speed, image reproduction, and resistance to striking-through.

Inconveniently, a sublimation printing method has, to name a few, the following disadvantages. It can be applied only to polyester fiber. Due to low molecular weights, some sublimation dyes have poor light-fastness, and their colors can migrate or fade during washing or under the heat of an iron. Due to high transfer temperatures, fiber can be compressed during transfer, leading to a degraded feel.

Against the background discussed above, there have been developed printing techniques that employ non-sublimation pigment ink and that can be applied to a wide range of fibers other than polyester fiber. For example, one known type of ink-jet printing ink is an ink composition containing a dispersion of a pigment with an average particle diameter of 200 μm or less and a maximum particle diameter of 500 μm or less, a water-soluble fixing agent, and a cross-linking agent, wherein a water-soluble pigment dispersing agent is obtained by neutralizing a particular emulsion polymer with a basic substance, the water-soluble fixing agent has a cross-linking functional group, and the cross-linking agent has a functional group that starts a cross-linking reaction with the cross-linking functional group of the water-soluble pigment dispersing agent and the cross-linking functional group of the water-soluble fixing agent at a temperature of 100° or higher.

For another example, one known type of ink-jet pigment printing ink is a pigment printing ink containing a pigment, water, and a water-soluble organic solvent, wherein the pigment is dispersed by a pigment dispersing agent, and the pigment dispersing agent is neutralized with a volatile amine and an inorganic base. For yet another example, a known transfer-printing method involves printing a pattern by ink-jet printing using a water-soluble dye on transfer paper coated with a hydrophilic sizing agent as an ink reception layer and then transferring the pattern to cloth containing a natural fiber as a main component.

### SUMMARY

According to one aspect of the present disclosure, transfer paper for transfer printing has an image formed on its surface with a water-based transfer-printing ink containing a pigment and a fixing resin ejected from an ink-jet recording device, and is then, with cloth laid over it, heated so that the image is transferred to the cloth. The transfer paper for transfer printing includes a base layer and a surface layer. The surface layer is composed of a hydrophilic ink reception layer laid on the base layer and a releasing layer forming agent containing an emulsion of hydrophobic particles having their surface coated with a hydrophilic emulsifier.

This and other objects of the present disclosure, and the specific benefits obtained according to the present disclosure, will become apparent from the description of embodiments which follows.

### BRIEF DESCRIPTION OF THE DRAWINGS

FIG. 1 is a sectional view of one example of a layered structure of transfer paper according to the present disclosure, showing a structure where an ink reception layer containing hydrophobic particles is laid, as a surface layer, on top of a base layer;

FIG. 2 is a sectional view of one example of a layered structure of transfer paper according to the present disclosure, showing a structure where a surface layer having a two-layer structure is formed by laying an emulsion layer and an ink reception layer successively on top of a base layer;

FIG. 3 is a sectional view of one example of a layered structure of transfer paper according to the present disclosure, showing a structure where a surface layer having a two-layer structure is formed by laying an ink reception layer and an emulsion layer successively on top of a base layer;

FIG. 4A is a diagram schematically showing a transfer paper preparing step (an image printing step) in a transfer-printing method according to the present disclosure;

FIG. 4B is a diagram schematically showing the transfer paper preparing step (a drying printing step) in the transfer-printing method according to the present disclosure;

FIG. 5A is a diagram schematically showing a transferring step in the transfer-printing method according to the present disclosure; and

FIG. 5B is a diagram schematically showing a releasing step in the transfer-printing method according to the present disclosure.

### DETAILED DESCRIPTION

A transfer-printing method involves first forming an image on transfer paper with non-sublimation transfer-printing ink (hereinafter also referred to simply as “ink”) on an ink-jet printer, then laying the transfer-printing transfer paper (hereinafter also referred to simply as “transfer paper”) having the image formed on it on cloth (such as woven fabric or knit fabric), and then applying at least heat and pressure so that the transfer-printing ink is transferred to the cloth. The transfer-printing ink contains a pigment and a fixing resin. The fixing resin does not cross-link on the transfer paper. The fixing resin cross-links when heated for transfer to the cloth, and it then bonds to the fiber of the cloth, providing enhanced adhesion of the image to the cloth.

In the present specification, unless specifically distinguished, “transfer paper” refers both to a transfer paper base that is used as a base when an image is formed by ejecting ink from an ink-jet printer and to transfer paper that is prepared by forming an image on a transfer paper base. Now, transfer-printing transfer paper and transfer-printing ink used in a transfer-printing method will be described.

### Transfer-Printing Transfer Paper

First, transfer paper according to the present disclosure for use in a transfer-printing method will be described. In a conventionally common sublimation transfer method, ink is printed on transfer paper and then the pigment is sublimated under heat so that an image is transferred to cloth. This is a chemical transfer method. On the other hand, according to the present disclosure, a fixing resin needed to fix a pigment to cloth is blended in transfer-printing ink, and the fixing resin, when heated with a transferring device, softens so that the pigment is, along with the fixing resin, transferred physically to cloth. The transfer is performed under conditions involving the application of, in addition to heat as in conventional practice, pressure, vibration, steam, and the like.

Transfer paper is required to have a blocking function whereby the transfer paper quickly receives water-based ink while blocking it from permeating the transfer paper and a releasing function whereby the transfer paper permits release of an ink component (ink layer) to cloth during transfer to it.

Base Layer:

A base layer functions as a base on top of which to apply an ink reception layer as will be described later or an emulsion layer for serving as a releasing layer during transfer, and is formed of craft paper or the like. If the base layer has a basis weight less than 40 g/m², with the performance of currently available ink-jet printers, a standard ink ejection amount causes the ink to seep into the transfer paper, resulting in cockling (waving); also, heating during transfer causes the transfer paper to shrink, resulting in lower adhesion to cloth as the target of transfer and leading to degraded quality of the transferred image. Moreover, reduced tensile and tearing strength makes paper breakage more likely. On the other hand, if the base layer has a basis weight more than 140 g/m², heat conducts to cloth poorly during transfer, resulting in lower efficiency of the transfer of ink to cloth. Out of these considerations, it is preferable that the base layer have a basis weight of 40 to 140 g/m², and more preferably 50 to 110 g/m².

Ink Reception Layer:

For quick reception of water-based ink, the transfer paper needs to have fine irregularities formed on its surface so as to absorb the ink. To that end, it is necessary to form a hydrophilic ink reception layer on the base layer. For the ink reception layer in the transfer paper, a hydrophilic (water-soluble) resin component such as carboxymethylcellulose sodium (hereinafter referred to as “CMC”) is used as a base material, and inorganic fine particles with an average particle diameter of 0.1 to 3.0 μm are blended. As the inorganic fine particles, fine particles of calcium carbonate or of silica are preferable, and fine particles of silica obtained by a wet process are more preferable.

CMC with a degree of polymerization less than 30 and a weight-average molecular weight less than 6600 has so low viscosity that the coating film (applied film) of the ink reception layer is prone to breakage, and is considered to be prone to develop defects in the continuous film. On the other hand, CMC with a degree of polymerization more than 80 and a weight-average molecular weight more than 18000 may lead to lower workability in the coating step. For example, CMC may have so high viscosity as to make coating difficult; reducing the viscosity by reducing the solid component may lead to an increased drying burden; reducing the viscosity by keeping a high temperature for a long time may adversely affect coating formation.

Accordingly, CMC with a degree of polymerization of 30 to 80 and a weight-average molecular weight of 6600 to 18000 is used suitably. In terms of viscosity and workability, CMC with a degree of polymerization of 30 to 80 and a weight-average molecular weight of 6600 to 18000 allows easy formation of an ink reception layer with few defects during coating, and also allows easy coating of the base layer with the ink reception layer.

As a water-soluble resin for the ink reception layer, it is possible to use, together with CMC, polyvinyl alcohol (hereinafter referred to as “PVA”). In particular, PVA with a degree of saponification of about 87 to 99 mol %, and preferably about 98 to 99 mol %, and a degree of polymerization of about 1700 or less, preferably 1000 or less, and more preferably 500 or less, exhibits good compatibility with CMC, and also is expected to provide an effect of keeping ink at the surface layer and an effect of enhancing the dispersibility of the inorganic particles blended in the water-soluble resin.

Releasing Layer Forming Agent:

To enable physical transfer of ink from transfer paper to cloth, an ink reception layer needs to have a function of releasing water-soluble ink. Specifically, it is necessary to provide, in addition to a hydrophilic ink reception layer that receives water-soluble ink, a hydrophobic releasing layer for releasing the ink to the cloth. However, if the releasing layer is present during image formation on the transfer paper, it hinders the absorption of ink into the ink reception layer. It is thus necessary that the releasing layer not be formed during image formation on transfer paper but be formed during transfer from transfer paper to cloth.

Accordingly, in the present disclosure, the releasing layer is formed by using an emulsion of hydrophobic particles as a releasing layer forming agent. In an emulsion of hydrophobic particles, the surface of hydrophobic particles is coated with an emulsifier (surfactant), and the surface is surrounded by hydrophilic functional groups, exhibiting affinity with water-based ink. Thus, when water-based ink lands on transfer paper, the hydrophobic particles are present in the form of emulsion and exhibits hydrophilicity; they thus do not function as a release agent. Under the heat during drying or transfer, the hydrophobic particles melt to form a hydrophobic releasing layer, enhancing the transferability of ink to cloth.

The drying temperature of transfer paper having an image formed on it by an ink-jet printer is about 50° C. Thus, when a material with a melting point lower than 50° C. is used as the releasing layer forming agent, a releasing layer is formed during drying. When a releasing layer is formed during drying, however, during the winding up of the transfer paper after drying, together with the releasing layer, part of the ink may transfer to the reverse side of the transfer paper, soiling the reverse side of the transfer paper. It is therefore preferable that, during the drying of transfer paper having an image formed on it with ink, the releasing layer forming agent not melt sufficiently to exert a releasing effect.

On the other hand, the transfer temperature to cloth is about 160° C. Thus, when a material with a melting point higher than 160° C. is used, it does not melt during transfer; it thus does not form a releasing layer, and does not exert a releasing effect. Out of these considerations, it is preferable that the releasing layer forming agent have a melting point of 50° C. or higher but 150° C. or lower, and more preferably 60° C. or higher but 140° C. or lower.

Examples of the releasing layer forming agent usable in the present disclosure include emulsions of hydrophobic particles such as wax emulsions based on natural wax, acrylic wax emulsions, acrylic silicone emulsions, and fluororesin emulsions. In a case where an emulsion of hydrophobic particles is blended in the ink reception layer, it is preferable that it be emulsified with a non-ionic emulsifier. This is because then the emulsifier coats the surface layer of the hydrophobic particles and permits the ink reception layer to receive water-based ink without repelling it.

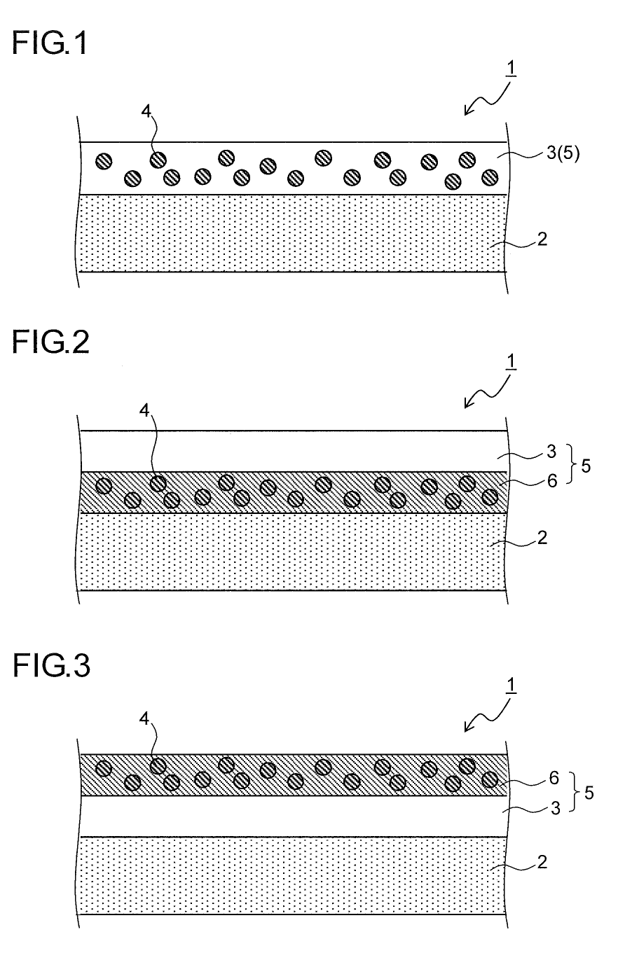

FIGS. 1 to 3 are sectional views showing examples of layered structures of transfer paper 1 according to the present disclosure. The transfer paper 1 can have, as shown in FIG. 1, a structure where, on top of a base layer 2, a surface layer 5 is formed in which an emulsion of hydrophobic particles 4 of which the surface is coated with an emulsifier is blended in a hydrophilic coating resin composition forming an ink reception layer 3 such that the hydrophobic particles 4 are present in the same layer as the ink reception layer 3. Instead, the transfer paper 1 can have, as shown in FIG. 2, a structure where a surface layer 5 having a two-layer structure is formed in which first a coating of an emulsion of hydrophobic particles 4 is laid on top of the base layer 2 to form an emulsion layer 6 containing the hydrophobic particles 4 and then a coating of a hydrophilic ink reception layer 3 is laid on top.

When the ink is transferred to cloth, together with the ink, part of the material of the surface layer 5 can be transferred to the cloth. When the releasing layer, which is formed of the hydrophobic particles 4 and the emulsion layer 6, is transferred, part of the releasing layer is, in a form mixed with the ink component, transferred to the cloth, contributing to enhanced luster and friction fastness. In a case where such effects are expected, as shown in FIG. 3, the emulsion layer 6 may be laid on the surface of the ink reception layer 3. The surface structure of the transfer paper 1 can be designed as necessary to suit the material and use (for example, fabric, leather, walling, etc.) of the cloth as the target of transfer.

It is preferable that the releasing layer forming agent content of the coating resin composition with which the base layer is coated be, in solid content, 1.0 to 20% by mass, and more preferably 2.0 to 10% by mass. A releasing layer forming agent content less than 1.0% by mass in solid content tends to lead to poor releasability. On the other hand, a releasing layer forming agent content more than 20% by mass may result in poor ink reception, leading to soiling of the reverse side of the transfer paper during its winding-up.

Transfer-Printing Ink

Next, ink for use in a transfer-printing method according to the present disclosure will be described. The ink is required to have landing stability when ejected at high speed onto transfer paper. Moreover, for satisfactory adhesion of an image to cloth, the added amount of fixing resin relative to the pigment needs to be increased. On the other hand, for satisfactory high-speed ejection out of ink-jet nozzles, it is necessary not to increase the ink viscosity over a certain level. That is, it is important to adjust the blended amount of fixing resin relative to the pigment in an adequate range.

Pigment:

As the pigment blended in the ink, any of conventionally known organic and inorganic pigments can be used. Examples include: azo pigments such as azo lakes, insoluble azo pigments, condensed azo pigments, and chelate azo pigments; polycyclic pigments such as phthalocyanine pigments, perylene and perylene pigments, anthraquinone pigments, quinacridone pigments, dioxazine pigments, thioindigo pigments, isoindolinone pigments, and quinophthalone pigments; dye lakes such as basic dye lakes and acid dye lakes; organic pigments such as nitro pigments, nitroso pigments, aniline black, daylight fluorescent pigments; and inorganic pigments such as carbon black. The pigment content of the ink is, preferably, 0.5 to 10% by mass.

With the pigment blended in the ink, considering that the pigment transferred to cloth is present near the surface of the cloth, it is important to reduce the particle diameter of the pigment particles to obtain enhanced color richness. Specifically, the average particle diameter of the pigment particles is 30 nm to 150 nm, and preferably 50 nm to 100 nm. An average particle diameter larger than 100 nm results in subdued color richness, and this leads to a reduced density of a printed article, making it impossible to obtain a sharp image.

On the other hand, with the average particle diameter of the pigment particles equal to or smaller than 50 nm, they tend to show low dispersion stability in the ink. The pigment may then flocculate, causing clogged ink-jet nozzles. To avoid that, in the pigment particles blended in the ink, it is preferable that the pigment particles be dispersed in the ink by a dispersion stabilizer or by the fixing resin that is present as a coating material, of which both will be described later. The average particle diameter of the pigment particles can be measured with a commercially available particle diameter measuring instrument employing a light scattering method, an electrophoresis method, a laser Doppler method, or the like. Measurement is also possible by taking images of at least 100 particles on a transmission electron microscope and then performing statistical processing using image analysis software.

Specific examples of the pigment blended in the ink are as follows. Examples of magenta or red pigments include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of orange or yellow pigments include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128, and C.I. Pigment Yellow 138.

Examples of green or cyan pigments include: C.I. Pigment Blue 15, C.I. Pigment Blue 15:2, C.I. Pigment Blue 15:3, C.I. Pigment Blue 16, C.I. Pigment Blue 60, and C.I. Pigment Green 7.

Fixing Resin:

It is preferable that the ink used in the present disclosure have, in addition to stability as ink, releasability from transfer paper and adhesion stability to cloth. It is preferable that the fixing resin blended in the ink be a water-dispersible resin that is insoluble in water. A water-dispersible resin is comparatively oil-soluble, and can be fixed so as to coat the entire pigment that has moved onto cloth; it thus allows the pigment to adhere to the cloth more firmly. In the present disclosure, it is important to bring the fixing resin into the most stable state with respect to water by neutralizing it with a base.

Examples of water-dispersible resins usable in the present disclosure includes: styrene-acrylic resin, silicone resin, polyester resin, and polyurethane resin; and copolymers having two or more of the just-named resins polymerized together, such as a copolymer of styrene-acrylic resin with polyester resin and a copolymer of styrene-acrylic resin with urethane resin. Moreover, it is important to use a design that allows, during transfer to cloth, part of the fixing resin to cross-link and bond firmly to the cloth to cause an increase in molecular weight or a hardening reaction. Accordingly, it is possible to use, as the fixing resin, any, having a reactive functional group, of a water dispersion of an acrylic monomer and polyisocyanate, a water dispersion of block polyisocyanate, and a water dispersion of glyoxal resin; or a copolymer containing some cross-linking agent.

Increasing the added amount of the fixing resin with a view to increasing the adhesion stability of the ink to cloth makes the cloth having an image transferred to it less flexible, giving it a coarse and hence degraded feel. To avoid that, it is preferable to use a resin, such as polyurethane resin, that has such a molecular structure as to retain flexibility after hardening.

As styrene-acrylic resin, it is possible to use a combination of one or more selected from the group consisting of styrene-(meth)acrylic acid copolymers and styrene-(meth)acrylic acid-(meth)acrylic acid ester copolymers. Examples of (meth)acrylic acid esters usable include benzyl (meth)acrylate, cyclohexyl (meth)acrylate, methyl (meth)acrylate, ethyl (meth)acrylate, propyl (meth)acrylate, butyl (meth)acrylate, hexyl (meth)acrylate, octyl (meth)acrylate, lauryl (meth)acrylate, 2-ethylhexyl (meth)acrylate, 2-ethylhexylcarbitol (meth)acrylate, EO-modified phenol (meth)acrylate, isobornyl (meth)acrylate, dicyclopentenyl (meth)acrylate, dicyclopentanyl (meth)acrylate, and dicyclopentenyloxyethyl (meth)acrylate.

Examples of silicone resin usable includes modified silicone oils of a side-chain type, a single-terminal type, a double-terminal type, a side-chain double-terminal type, and the like.

Examples of polyester resin usable include ester-bond polymers—including block copolymers, random copolymers, graft copolymers, and the like of such polymers—of a divalent carboxylic acid, such as terephthalic acid, isophthalic acid, orthophthalic acid, 2,6-naphthalenedicarboxylic acid, sulfoisophthalic acid, succinic acid, adipic acid, azelaic acid, sebacic acid, 1,10-decanedicarboxylic acid, or dimer acid, or a trivalent or higher-valence polyvalent carboxylic acid, such as trimellitic acid or pyromellitic acid, with a divalent alcohol, such as ethylene glycol, 1,2-propylene glycol, 1,3-propylene glycol, 1,4-butanediol, 1.5-pentanediol, 1,6-hexanediol, 1,9-nonanediol, neopentyl glycol, 3-methyl-1,5-pentanediol, diethylene glycol, triethylene glycol, polytetraethylene glycol, 1,4-cyclohexanedimethanol, or ethylene oxide-added bisphenol A, or a trivalent or higher-valence polyvalent alcohol, such as trimethylolpropane or pentaerythritol.

Examples of urethane resin usable include urethane-bond polymers—including block copolymers, random copolymers, graft copolymers, and the like of such polymers—of a polyol, such as polypropylene glycol, polyethylene glycol, polytetramethylene glycol, polyethylene adipate), poly(diethylene adipate), polypropylene adipate), poly(tetramethylene adipate), poly(hexamethylene adipate), poly-ε-caprolactone, poly(hexamethylene carbonate), or silicone polyol, with an isocyanate, such as trilene diisocyanate, 4,4-diphenylmethane diisocyanate, xylyrene diisocyanate, naphthalene diisocyanate, hexamethylene diisocyanate, hydrogenated trilene diisocyanate, hydrogenated 4,4-diphenylmethane diisocyanate, isophorone diisocyanate, or tetramethylxylyrene diisocyanate.

In the ink used in the present disclosure, the fixing resin may be present as a coating material around the pigment particles, or may be added as latex particles to the ink.

In a case where the fixing resin is made to be present as a coating material around the pigment particles, the pigment particles are dispersed in a polymer solution obtained by solution polymerization of a monomer so as to be subjected to phase-changing emulsification into an aqueous phase. This produces ink that is stable and in which the coated particles exhibit a sharp particle size distribution. It is preferable, from the perspectives of the storage stability and color richness of the ink, that the average particle diameter of the coated particles coated by the fixing resin be about 80 to 150 nm.

In a case where the fixing resin is added as latex particles to the ink, a pigment and a dispersion stabilizer are mixed and dispersed to prepare a dispersion of the pigment beforehand. The obtained dispersion of the pigment is then blended with latex along with other components such as a neutralizer, a solvent, and water to prepare ink.

A typical example of the latex added to the ink is a polyurethane latex. Polyurethane latexes include those obtained by adding an emulsifier to, and thereby emulsifying, an ordinary comparatively hydrophilic polyurethane resin and self-emulsifying emulsions having a functional group acting as an emulsifier introduced in a resin itself by a means such as copolymerization. Anionic self-emulsifying polyurethane emulsions usable in the ink according to the present disclosure belong to the latter. In terms of the adhesion and dispersion stability of the pigment, and in view of different combinations with dispersing agents, polycarbonate-based polyurethane resin emulsions are effective because they retain flexibility under weakly alkaline conditions and are fast. Care should be taken, however, because they tend to flocculate under acidic conditions.

Preferred examples of polycarbonate-based polyurethane resin emulsions are those with an acid value of 40 or more but 120 or less, a molecular weight of 500 or more but 50000 or less, and an average primary particle diameter of 150 nm or less, preferably 120 nm or less, and more preferably 100 nm or less. Generally, an average primary particle diameter less than 50 nm tends to result in poor dispersion stability in water.

The fixing temperature (cross-linking temperature) of the fixing resin to cloth is 100° C. to 200° C., preferably 120° C. to 190° C., and more preferably 140° C. to 180° C. With a fixing temperature of 100° C. or lower, hardening occurs at the temperature at which the ink on the transfer paper is dried, and this makes it impossible to obtain satisfactory fastness in friction fastness tests and the like after transfer to cloth. On the other hand, with a fixing temperature of 200° C. or higher, the fiber of cloth flattens, resulting in a degraded feel.

The blended amount of the fixing resin in the ink is such that the mass ratio of the fixing resin is 1 to 5 times that of the pigment, and preferably 1 to 3 times. With the mass ratio of the fixing resin lower than once that of the pigment, adhesion to fiber is insufficient, resulting in poor washing fastness and friction fastness. On the other hand, with the mass ratio of the fixing resin higher than 5 times that of the pigment, increased ink viscosity causes low ink ejection stability, and this makes it impossible to print stable images on transfer paper for a long period.

The acid value of the fixing resin is preferably 80 mg KOH/g or more but less than 300 mg. KOH/g, and preferably 90 mg KOH/g to 250 mg KOH/g. With the acid value of the fixing resin in the just-mentioned range, the copolymer exhibits notably increased viscosity when dried, and hardens to be firmer even after drying, resulting in good fixing of the pigment. The acid values defined in the present disclosure can be measured in conformity with JIS K 0070.

The molecular weight of the fixing resin usable in the present disclosure is, in terms of average molecular weight, preferably 2000 to 3000, and more preferably 5000 to 25000. The pKa (acid dissociation constant) of the fixing resin usable is preferably 4 to 8, and more preferably 5 to 7. In a case where the fixing resin is added as latex particles, it is preferable to use a fixing resin with a pKa lower than that of the dispersion stabilizer so that, after the dispersion stabilizer of the pigment particles has lost its dispersion stability and has precipitated, the fixing resin loses its dispersion stability.

Neutralizer:

The neutralizer is blended to neutralize the carboxyl groups in the fixing resin. During image formation on the transfer paper and during drying, the neutralizer remains in the ink image formed on the transfer paper, and the anionic fixing resin together with the pigment can maintain dispersion stability in the ink. Then, during image transfer to cloth, the fixing resin softens and gelates under heat, pressure, steam, and the like, allowing easy transfer of the image to the cloth. At this time, for increased hydrophobicity of the cloth, it is preferable that most of the neutralizer evaporate. Accordingly, as the neutralizer, it is particularly preferable to use a volatile amine.

A preferred volatile amine is one that has a boiling point of 50° C. or higher at ordinary pressure, is stable at ordinary temperature, and evaporates in a range of temperatures of 50° C. to 250° C. Considering that transfer to cloth can be performed at a temporarily raised vapor pressure, it is possible to use as the neutralizer an amine with a boiling point higher than 200° C. at ordinary pressure.

Examples of volatile amines usable in the present disclosure include triethylamine, 2-dimethylaminoethanol, 2-di-n-butylaminoethanol, methyldiethanolamine, 2-amino-2-methyl-1-propanol, diethanolamine, triethanolamine, and 2-methylaminoethanlol.

Water-Soluble Solvent:

The ink used in the present disclosure contains a water-soluble solvent. The kind and the blended amount of the water-soluble solvent can be selected and adjusted appropriately from the viewpoints of adjusting ejection stability from an ink-jet printer (ink viscosity), permeability to cloth, gelation speed, and the like. It is preferable that the viscosity of the transfer-printing ink according to the present disclosure be adjusted at 3 mPas to 10 mPas at 23° C.

Examples of water-soluble solvents usable in the transfer-printing ink according to the present disclosure include: alkyl alcohols with a carbon number of 1 to 4 such as methanol, ethanol, butanol, propanol, and isopropanol; glycol ethers such as ethylene glycol monomethyl ether, ethylene glycol monoethyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, dipropylene glycol mono-iso-propyl ether, propylene glycol mono-n-butyl ether, dipropylene glycol mono-n-butyl ether; propylene glycol, glycerin, formamide, acetamide, dimethylsulfoxide, sorbit, sorbitan, acetin, diacetin, triacetin, and sulfolane; and any mixture of what has just been named. The water-soluble solvent content of the transfer-printing ink is preferably 10 to 60% by mass.

As necessary, a film formation aid, a surfactant, an antiseptic, and the like can be further blended in the ink used in the present disclosure. The film formation aid is soluble in water and in a water-soluble solvent; it stays in the ink while water and the water-soluble solvent evaporate, and aids in forming a firm film when the fixing resin is melted and fused. Examples of film formation aids usable in the ink used in the present disclosure include glycol ethers with a comparatively high boiling point, such as tripropylene glycol n-butyl ether.

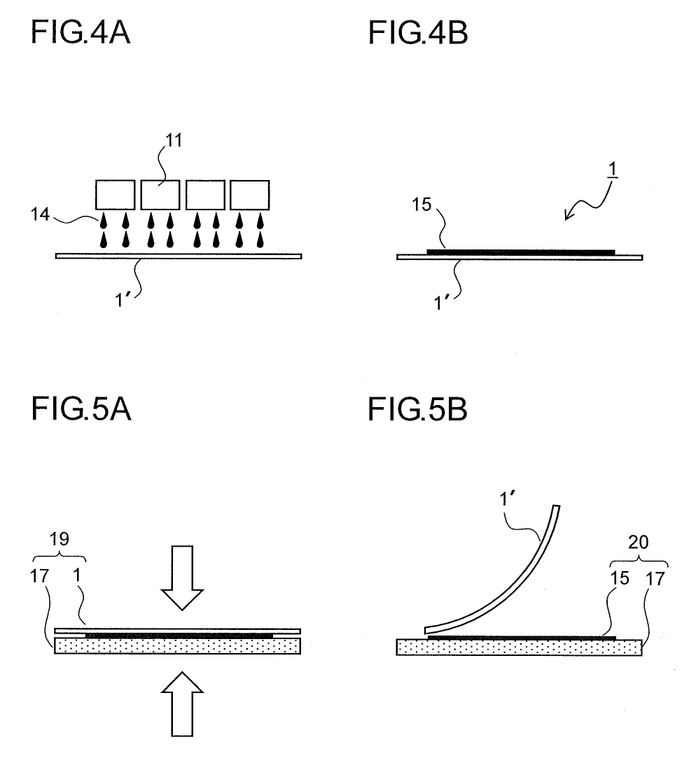

Next, a procedure of a transfer-printing method according to the present disclosure will be described. FIGS. 4A and 4B schematically show an image forming step in the transfer-printing method using transfer paper according to the present disclosure, and FIGS. 5A and 5B show a transferring step and a releasing step, respectively, in the transfer-printing method using transfer paper according to the present disclosure.

As shown in FIGS. 4A and 4B, using an ink-jet head 11, ink 14 is ejected onto a transfer paper base 1′ (transfer paper before image formation) to form an image, so that an ink layer 15 is formed; thus, transfer paper 1 is prepared (image forming step). In the image forming step, the ink reception layer 3 (see FIGS. 1 to 3) formed on top of the transfer paper base 1′ receives the ink 14 quickly, and thereby prevents the ink from seeping into the transfer paper base 1′.

Then, the transfer paper 1 having the ink layer 15 formed on it is dried (drying step). When the ink layer 15 is dried, drying is performed at a temperature lower than the cross-linking temperature (hardening temperature) of the fixing resin contained in the ink layer 15 and in addition lower than the melting point of the hydrophobic particles 4 contained in the surface layer 5 of the transfer paper base 1′ (for these, see FIGS. 1 to 3). In a case where the ink layer 15 contains a volatile amine as a neutralizer for the fixing resin, drying is performed at a temperature equal to or lower than the boiling point of the volatile amine contained in the ink layer 15. The drying temperature is, preferably, 100° C. or lower.

Next, as shown in FIGS. 5A and 5B, the transfer paper 1 is laid over one side of cloth 17, and the composite 19 of the cloth 17 and the transfer paper 1 thus laid together is subjected to application of pressure and heat, so that the ink layer 15 on the transfer paper 1 is transferred to the cloth 17 (transferring step).

Used as the cloth 17 is a woven fabric, knit fabric, or non-woven fabric made of one or two or more kinds of fibrous materials selected from the group consisting of cellulose fibers such as cotton, hemp, and rayon; protein fibers such as silk and wool; and synthetic fibers such as nylon, vinylon, and polyester.

In the transferring step, the composite 19 is heated at a temperature higher than the cross-linking temperature of the fixing resin contained in the ink layer 15 and in addition higher than the melting point of the hydrophobic particles 4 contained in the surface layer 5 of the transfer paper 1. In a case where the ink layer 15 contains a volatile amine as a neutralizer for the anionic fixing resin, the composite 19 is heated at a temperature equal to or higher than the boiling point of the volatile amine. Thus, immediately after the start of transfer, the volatile amine remaining in the ink layer 15 makes the ink layer 15 hydrophilic and lets it soften (gelate). Moreover, the hydrophobic particles 4 melt to form a hydrophobic releasing layer. Thus, the ink layer 15 is transferred easily to the cloth 17, turning into film in close contact with the cloth 17. As the transferring step proceeds, the volatile amine evaporates, and makes the ink layer 15 hydrophobic. Thus, the ink layer 15 having turned into film attaches firmly to the cloth 17.

The heating in the transferring step causes the moisture contained in the transfer paper 1 to become steam and thereby promotes the hydrophilization (softening) of the ink layer 15. Accordingly, prior to the transferring step, a moisture-impregnating step of impregnating the cloth 17 with moisture can be added to promote the softening of the ink layer 15 and to improve the transferability of the ink layer 15 to the cloth 17.

With the heating temperature (transferring temperature) during the transferring step lower than 100° C., it is close to the drying temperature of the ink layer 15 during the image forming step. Thus, the ink layer 15 on the transfer paper 1 hardens during drying, and the volatile amine in the ink layer 15 does not evaporate sufficiently. This leads to insufficient fastness in the friction fastness tests and the like after transfer to the cloth 17. On the other hand, with the heating temperature during the transferring step higher than 200° C., the fiber of the cloth 7 flattens, giving it a degraded feel. Accordingly, the heating temperature in the transferring step needs to be 100° C. or higher but 200° C. or lower, preferably 120° C. to 190° C., and more preferably 140° C. to 180° C.

Next, the transfer paper base 1′ is released from the composite 19 (releasing step). In this way, a printed article 20 is produced that has the ink layer 15 transferred in the form of film to the cloth 17. Thereafter, as necessary, it is possible to perform a cleaning step to remove unnecessary substances in the printed article 20, such as the unfixed pigment and the fixing resin, and a drying step to dry the printed article 20 having undergone the cleaning step.

The layer thickness of the ink layer 15 transferred to the cloth 17 is preferably 50 nm to 200 nm, and more preferably 50 nm to 100 nm. With the layer thickness of the ink layer 15 equal to or larger than 500 nm, the cloth 17 feels coarse and has degraded friction fastness, and the cloth 17 has a degraded feel. Moreover, since the particle diameter of the pigment particles is typically 50 nm to 100 nm, even if part of the pigment particles lodge in the fiber of the cloth 17, the minimum value of the layer thickness is about 40 nm to 80 nm.

As a method of measuring the layer thickness of the ink layer 15 transferred to the cloth 17 and turned into film, an ion beam method as described below is used. The cloth 17 having the ink layer 15 transferred to it is embedded in an ultraviolet-curable resin, and is then irradiated with a UV lamp so that the ultraviolet-curable resin hardens; then, samples for measurement are cut out. The section of each cut-out sample is inspected on a transmission electron microscope (TEM) to measure the layer thickness of the ink layer 15. Measurements are taken at 20 observation points, and their average value is calculated.

The layer thickness of the ink layer 15 transferred to the cloth 17 is correlated with the layer thickness of the ink layer 15 formed on the transfer paper base1′. For the ink layer 15 transferred to the cloth 17 to have a layer thickness of 50 nm to 200 nm, the ink layer 15 formed on the transfer paper base1′ can be formed with a layer thickness of 50 nm to 500 nm. The layer thickness of the ink layer 15 formed on the transfer paper base1′ can be measured by an ion beam method as with the layer thickness of the ink layer 15 transferred to the cloth 17.

With the transfer-printing method according to the present disclosure, an ink layer 15 is formed on a transfer paper base1′ with an ink-jet head 11. Thus, even if the image formed by the ink-jet head 11 is inappropriate, expensive cloth 17 does not have to be scrapped. Moreover, compared with a case where the image is formed directly on the cloth 17 with the ink-jet head 11, the distance between the ink-jet head 11 and the transfer paper base1′ can be set to be shorter. This allows production of transfer paper 1 having an image printed on it with high quality.

Moreover, printing is possible on various kinds of cloth 17 other than polyester, and the pigment can be fixed near the surface of the cloth 17. This allows production of printed articles with sharper images than ever, and the produced printed articles show excellent fastness. Furthermore, no preprocessing or postprocessing of the cloth 17 is required, and no waste is produced other than the used transfer paper base1′. Thus, a printing method that poses little burden on the environment and that boasts a wide scope of application is provided.

The present disclosure is not limited in any way by the embodiments described above, and allows for any modifications within the scope of the present disclosure. For example, although the above embodiments deal with a transfer-printing method of a batch type in which a composite 19 having transfer paper 1 and cloth 17 laid together is pressed from both above and below, the present disclosure is applicable similarly to a transfer-printing method of a continuous type in which, while transfer paper 1 and cloth 17, both in a form continuous and wound in a roll, are fed out at predetermined speed, they are laid together to form a composite 19, then, while this is passed between a heating and a pressing roller, an ink layer 15 is transferred to the cloth 17, and then the transfer paper base1′ is released while it is would up. The effects of the present disclosure will be described more specifically below by way of examples.

### Examples I

Preparing Transfer Paper:

As the base layer, craft paper with a basis weight of 70 g/m², a Beck smoothness (JIS P8119) of 100 seconds, and a 10-second Cobb water absorbency (JIS P8140) of 10 g/m² was used. CMC (Cellogen 5A, manufactured by DKS Co. Ltd.) as a water-soluble resin and fine-particle synthetic amorphous silica powder with an average particle diameter of 3.7 μm (Fine Seal X-37B, manufactured by OSC Japan) were blended in a mass ratio of 200:100 to obtain a hydrophilic coating agent with a solid content of 17%. Then, as a releasing layer forming agent, a wax emulsion with a particle diameter of 160 nm and a melting point of 135° C. (Aquacer 531, manufactured by BYK Japan) was blended such that the wax solid content relative to the hydrophilic solid content was 5% by mass. The blend was then applied with a thickness of 7 μm to the base layer to form an ink reception layer containing wax particles. Thus, transfer paper according to the present disclosure was prepared (Practical Example (P.Ex.) 1).

Instead of the wax emulsion with a particle diameter of 160 nm and a melting point of 135° C. (Aquacer 531, manufactured by BYK Japan), a wax emulsion with a particle diameter of 0.5 μm and a melting point of 83° C. (EMUSTAR-0413, manufactured by Nippon Seiro Co., Ltd.) was used. Otherwise, transfer paper according to the present disclosure was prepared through a procedure similar to that described above (Practical Example (P.Ex.) 2).

As one comparative example, a base layer similar to that described above was as it was used as transfer paper (Comparative Example (C.Ex.) 1). As another comparative example, transfer paper was prepared through a procedure similar to those for Practical Examples 1 and 2 except that no wax emulsion was blended in the hydrophilic coating agent (Comparative Example (C.Ex.) 2).

### Examples II

Preparing Dispersion of Pigment:

20% by mass of a phthalocyanine pigment (Pigment Blue 15:3), 5% by mass of a styrene-acrylic resin (with a molecular weight of 5000) as a dispersion stabilizer, and 75% by mass of ion-exchanged water were blended. The blend was then subjected to high-speed dispersion on a thin-film spin system high-speed mixer (FILMIX, manufactured by PRIMIX Corporation), and was then subjected to dispersion on a beads mill (DYNO-MILL, manufactured by Shinmaru Enterprises Corporation) until the grain size was 80 nm to obtain a dispersion of the pigment. The dispersion of the pigment had a viscosity of 8 mPas.

Preparing Transfer-Printing Ink:

As shown in Table 1, the previously prepared dispersion of the pigment was blended such that the pigment component was 5% by mass. Further, propylene glycol and glycerin as a water-soluble solvent and Surfynol 104 (an acetylene glycol-based surfactant, manufactured by Nissin Chemical Industry Co., Ltd.) as a surfactant were blended. Further, as a fixing resin, polyurethane latex (UPUD-ST-008, manufactured by UBE INDUSTRIES, LTD., with a cross-linking start temperature of 140° C.) was blended such that its blended amount was 10% by mass in solid content. Further, as a neutralizer, triethylamine (with a boiling point of 89° C.) was blended in the equivalent amount calculated with respect to the acid value of the fixing resin. Further, ion-exchanged water was blended such that the total was 100% by mass. The blend was then stirred to obtain transfer-printing ink.

Forming Image on Transfer Paper:

On the transfer paper (in size A4) of each of Practical Examples 1 and 2 and Comparative Examples 1 and 2 prepared in Examples I, a solid image with a density of 100% was formed using the transfer-printing ink on an ink-jet printer equipped with an ink-jet head (KJ4B, manufactured by KYOCERA Corporation). The image formation speed was 50 m/s. The transfer paper base having the image formed on it was dried for 10 minutes at 60° C.

Producing Printed Article:

Cotton cloth was laid over the so prepared transfer paper, and transfer was performed for one minute at 160° C. and 1 MPa to obtain a printed article.

### Examples III

Evaluating Ejection Stability and Transferability of Transfer-Printing Ink, and Washing Fastness of Printed Article:

The continuous ejection stability of the ink composition was evaluated according to the following criteria:
Excellent (“Excel.”): Solid-image printing on 150 A4 sheets completed with no missing dot.
Good: Solid-image printing on 150 A4 sheets completed with one or more but 10 or less missing dots.
Poor: Solid-image printing on 150 A4 sheets completed with 11 or more missing dots.

In regard to transferability, the efficiency of transfer (the ratio of transfer to cloth) was calculated by measuring the amount of ink left untransferred to the transfer paper and the amount of ink transferred to the cloth, and was evaluated according to the following criteria:
Excellent (“Excel.”): A transfer efficiency of 90% or more.
Good: A transfer efficiency of 80 to 90%.
Poor: A transfer efficiency of 80% or less.

The washing fastness of the printed article was tested by a method conforming to ISO 105-C10:2006, and was evaluated according to the following criteria:
Excellent (“Excel.”): Washing fastness of grade 4 or higher.
Good: Washing fastness of grade 3 or higher but lower than grade 4.
Poor: Washing fastness lower than grade 3.

TABLE 1

| | Boiling | | | | |
|---|---|---|---|---|---|
| | Point | | | | |
| Ink Components | (° C.) | P. Ex. 1 | P. Ex. 2 | C. Ex. 1 | C. Ex. 2 |
| Pigment Blue 15:3 | | 5 | 5 | 5 | 5 |
| (Pigment Only) | | | | | |
| Propylene Glycol | 188 | 15 | 15 | 15 | 15 |
| Glycerin | 290 | 10 | 10 | 10 | 10 |
| Triethylamine | 89 | 1 | 1 | 1 | 1 |
| (Neutralization | | | | | |
| Equivalent) | | | | | |
| Surfynol 104 | | 0.5 | 0.5 | 0.5 | 0.5 |
| Polyurethane Latex | | 10 | 10 | 10 | 10 |
| (Solid) | | | | | |
| Ion-Exchanged Water | | Rest | Rest | Rest | Rest |
| Ink Viscosity (MPa) | | 5 | 6 | 5 | 6 |
| Ejection Stability | | Good | Good | Good | Good |
| Transferability | | Good | Excel. | Poor | Poor |
| Washing Fastness | | Good | Excel. | Poor | Poor |

As Table 1 clearly indicates, with the transfer paper of Practical Example 1, in which a wax emulsion with a particle diameter of 160 nm and a melting point of 135° C. was blended in the ink reception layer, the efficiency of transfer of the ink from transfer paper to cloth was as high as 80 to 90%, and the washing fastness of the printed article was grade 3 or higher. With the transfer paper of Practical Example 2, in which a wax emulsion with a particle diameter of 0.5 μm and a melting point of 83° C. was blended, the efficiency of transfer of the ink from transfer paper to cloth was even higher, at 90% or more, and the washing fastness of the printed article was grade 4 or higher

In contrast, with the transfer paper of Comparative Example 1, in which the craft paper as the base layer was used as it is, and also with the transfer paper of Comparative Example 2, in which no wax emulsion was blended in the ink reception layer, the efficiency of transfer of the ink from transfer paper to cloth was as low as 80% or less, and the washing fastness of the printed article was less than grade 3.

In all of Practical Examples 1 and 2 and Comparative Examples 1 and 2, the ink viscosity at 23° C. was in a range of 5 to 6 mPas, and continuous printing on 150 sheets of the transfer paper resulted in 10 or less missing dots, attesting to superb ejection stability.

The results of Examples III reveal the following. Using transfer paper in which a wax emulsion is blended in the ink reception layer results in high transfer efficiency when an image is transferred from the transfer paper to cloth as well as superb washing fastness of the printed article produced. Though omitted from description here, it has also been confirmed that similar effects are obtained with transfer paper in which the surface layer has a two-layer structure where a coating of a wax emulsion is laid on top of a base layer and then a coating of a hydrophilic ink reception layer is laid on top and with transfer paper in which the surface layer has a two-layer structure where a coating of a hydrophilic ink reception layer is laid on top of a base layer and then a coating of a wax emulsion is laid on top.

The present disclosure finds application in transfer-printing methods that involve transferring an image recorded on transfer paper with an ink-jet recording device to a recording sheet. According to the present disclosure, it is possible to print images easily and with high quality on recording sheets of varying materials with pigment ink, and it is possible to provide transfer-printing methods that do not require preprocessing or postprocessing of recording sheets.

What is claimed is:

1. Transfer paper for transfer printing, comprising:
a base layer; and
a surface layer composed of
a hydrophilic ink reception layer laid on the base layer and
a releasing layer forming agent containing an emulsion of hydrophobic particles having a surface thereof coated with a hydrophilic emulsifier,
wherein
an image is formed on a surface of the transfer paper with a water-based transfer-printing ink containing a pigment and a fixing resin ejected from an ink-jet recording device, and the transfer paper is then, with cloth laid over it, heated so that the image is transferred to the cloth.

2. The transfer paper according to claim 1, wherein
the surface layer is the ink reception layer containing the emulsion of the hydrophobic particles as the releasing layer forming agent.

3. The transfer paper according to claim 1, wherein
the surface layer is composed of
the ink reception layer and
an emulsion layer of the hydrophobic particles formed between the base layer and the ink reception layer.

4. The transfer paper according to claim 1, wherein
the surface layer is composed of
the ink reception layer and
an emulsion layer of the hydrophobic particles formed on a surface of the ink reception layer.

5. The transfer paper according to claim 1, wherein
a blended amount of the releasing layer forming agent in the surface layer is 1.0 to 20% by mass in solid content.

6. The transfer paper according to claim 1, wherein
a melting point of the releasing layer forming agent is 50° C. or higher but 150° C. or lower.

7. The transfer paper according to claim 1, wherein
the emulsion of the hydrophobic particles is a wax emulsion.

8. The transfer paper according to claim 1, wherein
the ink reception layer is formed of a hydrophilic resin containing inorganic fine particles.

9. The transfer paper according to claim 8, wherein
the hydrophilic resin is carboxymethylcellulose sodium.

10. The transfer paper according to claim 8, wherein
the inorganic fine particles are fine particles of silica.
